(19) United States
(12) Patent Application Publication
(10) Pub. No.: US 2024/0242643 A1
(43) Pub. Date: Jul. 18, 2024

(54) METHOD AND APPARATUS FOR PROJECTING IMAGES ON SURFACES

(71) Applicant: KONE Corporation, Helsinki (FI)

(72) Inventors: Jouni JUNES, Helsinki (FI); Claudio STUPPI, Helsinki (FI); Markus HAUTAKORPI, Helsinki (FI); Tero KÖNÖNEN, Helsinki (FI); Michihito MIZUTANI, Helsinki (FI)

(73) Assignee: KONE Corporation, Helsinki (FI)

(21) Appl. No.: 18/619,946

(22) Filed: Mar. 28, 2024

Related U.S. Application Data
(63) Continuation of application No. PCT/FI2021/050741, filed on Nov. 1, 2021.

(51) Int. Cl. G09G 3/00; B66B 3/00; B66B 27/00; G06F 3/01

(52) U.S. Cl. CPC G09G 3/001; B66B 3/002; B66B 3/006; B66B 3/008; B66B 27/00; G06F 3/011; G09G 2330/12; G09G 2354/00

(57) ABSTRACT

The present invention relates to a method and projection display apparatus for presenting information in a space. Projected images are dynamically adjusted based on detection of changes in the space, determining a level of crowdedness in the space and/or detecting a failure of projection.

### FIELD

The present invention relates to a method, a system and a computer program product related to projecting images comprising information elements. More particularly, the invention relates to a method, a system and a computer program product that enables dynamical adaptation of projected images in dependence of detected characteristics of the space.

### BACKGROUND

Developments in projector technologies have made projection as a feasible alternative to replace more traditional, physical display devices with projectors that are capable of projecting information on many types of surfaces. No specific projection screen cloths are required any more for clear and intelligible projected images with good quality.

### DESCRIPTION OF THE RELATED ART

Patent application CN107065409 A discloses dynamic projection that adjusts position of the projected information based on a user's activity detected with 3D-IR testers or cameras. The system has projection autofocus, image/direction correction, background, brightness, and surface unevenness correction as well as projection image distortion correction and direction correction.

### SUMMARY

An object is to provide a method and apparatus so as to solve the problem of optimizing effectivity and intelligibility of information provided by projecting images on one or more surfaces. The objects of the present invention are achieved with a method according to the claim 1. The objects of the present invention are further achieved with an apparatus according to the claim 10, and a computer program product according to the claim 18.

The preferred embodiments of the invention are disclosed in the dependent claims.

According to a first method aspect, a method for presenting information in a space by a projection display apparatus comprising at least one projector is provided. The method comprises projecting, by said projection display apparatus, at least one image on at least one surface within the space, the at least one image comprising at least one information element. The method comprises i) detecting a change in the space and/or one or more zones within the space based on at least one of: a change in building information management (BIM) data received from a BIM system, sensor data received from at least one sensor associated with or included in the projection display apparatus, data received from an elevator control system; and/or ii) determining a level of crowdedness of the space and/or one or more zones within the space based on sensor data received from at least one sensor associated with or included in the projection display apparatus; and/or iii) detecting a failure of projection at least one image based on sensor data received from the at least one sensor based on the image not fulfilling predefined quality criteria. The method comprises adjusting content, location and/or size of the at least one projected image based on the detected change in the space and/or the determined level of crowdedness of the space and/or the detected failure of projection.

According to a second method aspect, the space is any one of an elevator lobby and a lobby with a security gate and/or an escalator landing.

According to a third method aspect, size and/or brightness of the at least one information element is increased when the determined level of crowdedness of the space and/or one or more zones within the space exceeds a predetermined threshold value.

According to a fourth method aspect, projecting at least one information element is suspended when the determined level of crowdedness of the space and/or one or more zones within the space exceeds a predetermined threshold value.

According to a fifth method aspect, said at least one image comprises at least one information element projected on a floor surface of the space. Projecting the at least one information element on the floor surface is suspended i) on basis the detected change in the space and/or in one or more zones within the space, and/or ii) when the determined level of crowdedness of the space and/or in one or more zones within the space exceeds a predetermined threshold value, and/or iii) when a failure of projection of the at least one image on the floor surface is detected, and/or projecting the at least one information element on the floor surface is automatically switched into projecting the at least one information element on a wall surface of the space i) on basis the detected change in the space and/or in one or more zones within the space, and/or ii) when determined level of crowdedness of the space and/or in one or more zones within the space exceeds a predetermined threshold value, and/or iii) when a failure of projection of the at least one on the floor surface is detected.

According to a sixth method aspect, the at least one surface is at least one door leaf, and wherein the at least one image projected on the at least one door leaf is dynamically adjusted according to status and/or movement of the at least one door leaf based on at least one of the sensor data and the data received from the elevator control system.

According to a seventh method aspect, the space is an elevator lobby and wherein information comprises at least one of a hall lantern of an elevator, a destination guidance display, an elevator guide, an elevator direction indicator and a current floor indicator next to a landing device, an elevator identification information, a progress bar for elevator arrival, a time estimate for elevator arrival, an indication of elevator doors opening, a warning on closing elevator doors, an elevator out of order indication, an elevator out of service indication, a destination name and/or a logo associated with the destination, emergency markings for firemen elevators, guidance for users, such as guidance for not to use elevators in case of fire, amount of people currently in the elevator, building information, advertising, decorative projections, building branding, elevator branding, infotainment, and advertisement.

According to an eighth method aspect, the method comprises adjusting and/or calibrating the at least one projected image based on a three-dimensional map or model of the space generated based on at least one of the BIM data and the sensor data.

According to a ninth method aspect, the at least one sensor comprises at least one of a camera, a camera array, a laser radar, a microwave radar and a wireless vision (Wi-Vi) apparatus.

According to a first apparatus aspect, an apparatus for presenting information in a space is provided. The apparatus comprises a projection display apparatus configured to project at least one image on at least one surface within the space, the at least one image comprising at least one information element representing a piece of said information, at least one sensor associated with or included in the projection display apparatus, and optionally, an interface for receiving building information management (BIM) data from a BIM system, and optionally, an interface for receiving information from an elevator control system. The apparatus comprises at least one of a first module, a second module and a third module. The first module is configured to determine a level of crowdedness of the space and/or one or more zones within the space based on sensor data received from said at least one sensor. The second module configured to detect a change in the space and/or one or more zones within the space based on at least one of: a change in the BIM data, sensor data received from at least one sensor associated with or included in the projection display apparatus, data received from the elevator control system. The third module is configured to detect a failure of projecting the at least one image based on sensor data received from the at least one sensor, wherein the failure is detected based on the image not fulfilling predefined quality criteria. The apparatus further comprises a fourth module configured to automatically adjust content, location and/or size of the projected image based on i) a detected change in the space and/or one or more zones within the space and/or ii) the determined level of crowdedness of the space and/or one or more zones within the space and/or iii) the detected failure of projecting the projected image.

According to a second apparatus aspect, the fourth module is configured to increase the size and/or brightness of the at least one information element when the determined level of crowdedness of the space and/or one or more zones within the space exceeds a predetermined threshold value.

According to a third apparatus aspect, the fourth module is configured to cause suspending of projecting at least one information element when the determined level of crowdedness of the space and/or one or more zones within the space exceeds a predetermined threshold value.

According to a fourth apparatus aspect, said at least one image comprises at least one information element projected on a floor surface of the space, and wherein the fourth module is configured to cause projecting the at least one information element on the floor surface to be suspended i) on basis the detected change in the space and/or in one or more zones within the space, and/or ii) when the determined level of crowdedness of the space and/or one or more zones within the space exceeds a predetermined threshold value, and/or iii) based on the detected failure of projecting the at least one image, and/or the third module is configured to cause automatically switching from projecting the at least one information element on the floor surface into projecting the at least one information element on a wall surface of the space i) on basis the detected change in the space and/or in one or more zones within the space, and/or ii) when determined level of crowdedness of the space and/or one or more zones within the space exceeds a predetermined threshold value and/or iii) based on the detected failure of projecting the at least one image.

According to a fifth apparatus aspect, the at least one surface is at least one door leaf, and wherein the apparatus comprises a fifth module configured to dynamically adjust the at least one projected image projected on the at least one door leaf according to status and/or movement of the at least one door leaf based on at least one of the sensor data and the data received from the elevator control system.

According to a sixth apparatus aspect, the space is an elevator lobby and wherein said information comprises at least one of a hall lantern of an elevator, a destination guidance display, an elevator guide, an elevator direction indicator and a current floor indicator next to a landing device, an elevator identification information, a progress bar for elevator arrival, a time estimate for elevator arrival, an indication of elevator doors opening, a warning on closing elevator doors, an elevator out of order indication, an elevator out of service indication, a destination name and/or a logo associated with the destination, emergency markings for firemen elevators, guidance for users, such as guidance for not to use elevators in case of fire, amount of people currently in the elevator, building information, advertising, decorative projections, building branding, elevator branding, infotainment, and advertisement.

According to a seventh apparatus aspect, the apparatus further comprises a fifth module configured to generate a three-dimensional map or model of the space based on at least one of the BIM data and the sensor data, wherein the third module or a fifth module is further configured to adjust and/or calibrate the at least one projected image based on said three-dimensional map or model.

According to an eighth apparatus aspect, the at least one sensor comprises at least one of a camera, a camera array, a laser radar, a microwave radar and a wireless vision (Wi-Vi) apparatus.

According to another aspect, a computer program product is provided that comprises computer executable code that causes, when run on a computer device or system, an apparatus according to any one of the apparatus aspects to perform the method according to any one of the above method aspects.

The present invention is based on the idea of automatically adjusting projection of images comprising information elements on one or more surfaces of a space based on detecting characteristics of the space by one or more sensors associated with the projection device. In particular, projection of images providing information on one or more surfaces of the space is adjusted automatically based on detected crowdedness of the space. Crowdedness of the space may be caused humans or non-human things, such as animals, furniture, luggage, packages, tools, equipment, or a combination of these.

The present invention has the advantage that projected images can be optimized for different circumstances, while usefulness and visibility of the projected information elements is improved and optimized for different levels of crowdedness. Energy can be saved by not projecting unusable images on some of the surfaces of the space, when is likely that information elements provided by these images could not in practice be observed by people in the space. The system and method are also user-friendly to members of the crowd by avoiding glare that could be caused by projecting information elements on ‘wrong’ surfaces of the space when it is determined to be crowded.

### BRIEF DESCRIPTION OF THE DRAWINGS

In the following the invention will be described in greater detail, in connection with preferred embodiments, with reference to the attached drawings, in which

FIG. 1 illustrates an elevator lobby with projected images.

FIG. 2 illustrates an enlarged view of content of some projected information elements comprised in the projected images.

FIG. 3 illustrates zones in a space.

FIG. 4 illustrates dynamic adjustment of a projection on door leaves.

FIG. 5 shows schematically an apparatus.

FIG. 6 illustrates method steps.

### DETAILED DESCRIPTION

In the following description, terms passenger and people refer to a person/persons residing in the space, arriving to the space and/or leaving the space. As commonly known, the term crowded refers not only to fitting humans, but also to animals and non-living things in a limited space.

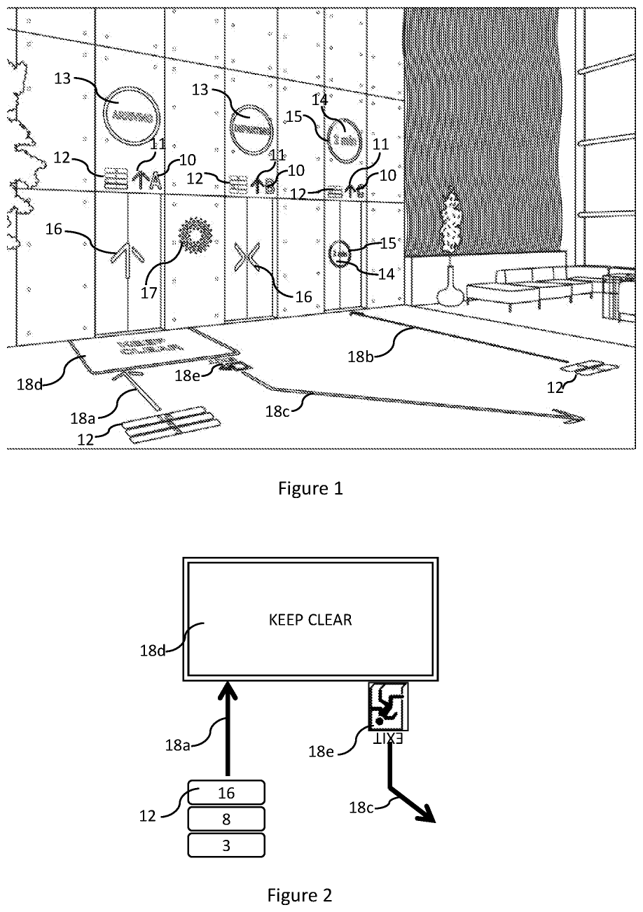

The FIG. 1 shows an exemplary space, which in this example is an elevator lobby, with a plurality of exemplary projected images showing various pieces of information primarily to passengers within the lobby. Alternate spaces in which the same idea is applicable are for example lobbies with a security gate and escalator landings.

Projected pieces of information, also referred to as information elements in the projected images can replace any physical information display devices, in particular any physical information delivery and/or display devices such as lanterns and other known signage devices and various physical information display apparatuses such as CRT, LCD, LED, DVXT, 3D and plasma displays, provided in the lobby. When projection is used, any information elements can be projected in practice on any selected surface of the space. As known in the art, a single projected image may comprise more than one information element and more than two projected images may be blended to provide at least one information element.

In this example, an identification (10) of the respective elevator, a direction indicator (11) that indicates which direction the elevator is or will be available to serve passengers, and destination floor lists (12), showing currently assigned destination floors for each individual elevator car are projected on the wall surface. Further up on the wall, a first status indicator (13) of each respective elevator car is projected, which may be dynamically changed into a projection of time estimate (14) and/or a progress bar (15) for elevator car arrival, depending on each elevator car's individual status.

A second status indicator (16) may be projected on respective elevator doors, and this information element can be further dynamically changed into a projection of a time estimate (14) and/or a progress bar (15) indicating expected time for elevator car arrival. Any of the first or second status indicator (13, 16) may also be used for indicating opening or closing of elevator doors, thus operating as passenger guidance and/or as a warning. One or more decorative and/or branding images (17) may be projected on any surface. Advertisement content and/or entertainment may also be projected (not shown).

On the floor surface of the exemplary lobby shown in the FIG. 1, several passenger guidance information elements are projected. Destination floor lists (12) may also be projected on the floor surface, and this information can be further enhanced by passenger guiding arrows (18a, 18b, 18c) and/or other projected guidance elements (18d, 18e). In this example, projected arrows (18a, 18b) indicate suggested direction of movement to enter the elevator car destined to the respective destination floor indicated by the destination floor list (12), and a suggested way (18c) to exit the elevator and/or the lobby. Another passenger guidance information element is projected on the floor that shows an area (18d) before the door of an arriving elevator that should be held clear to allow any arriving passengers to exit the elevator first, before new passengers enter the elevator car. This kind of passenger guidance information element is preferably also dynamic, thus displayed only if there are currently passengers in the elevator car who are expected to leave the respective elevator car at this floor. If the elevator car is known to be empty, or the passengers in the elevator car are determined to be destined to a different floor, such clearance space may not be needed on this landing. Another passenger guidance information element (18e) identifies an exit route together with the associated arrow (18c). Such guidance towards an exit route may be particularly useful in an emergency, ensuring that any passengers arriving to the lobby with the elevator know immediately which way to move to promptly exit the lobby and/or the building. Projected passenger guidance information elements may comprise graphical and/or textual content.

FIG. 1 illustrates an empty, in other words uncrowded lobby area, showing information elements projected on the floor, on the elevator doors and on the adjacent walls. However, usefulness of some of the projected information elements becomes poor, if the lobby area is crowded by people (passengers), animals and/or items. Information elements projected on the floor may become blocked by the people, animals and/or items occupying the lobby and may be no more useful for guidance purposes. Furthermore, people and/or animals may find some projections causing glare, especially when light emitted by the projection device to project any information element falls at or near eyes of a person or an animal.

Therefore, some of the projected information elements should be automatically and dynamically switched off or relocated in a more suitable projection location when the lobby is determined to be crowded. Content of the off-switched or relocated information elements can be projected on another surface, which is determined to be well visible even if the space is crowded. For example, projection of some of the information elements can be switched on the wall or on the elevator door instead of projecting them on the floor. If the same information content is projected in normal, i.e. non-crowded circumstances both on the floor and on another surface, projected information elements may be altered in association of dynamically switching off some of the information elements. For example, size and/or brightness of the information elements projected on the wall or on the elevator door may be increased, or position thereof may be changed in order to ensure visibility thereof to passengers, if information elements are not projected on the floor.

In some embodiments, some of the information elements may be projected on the floor only, when the space is determined not to be crowded, and dynamically switched to be projected on the floor and/or the elevator doors, when the space is determined to be crowded.

When information elements are projected on elevator doors, projection is preferably adjusted based on position of the doors to avoid causing glare for passengers when the doors are not closed. According to some embodiments, the projection on elevator door is switched off when the door is opened and switched on when the door is closed. According to some embodiments, information element or elements projected on the door is/are moved along with movement of door leaf(s) and can thus be kept visible as long as there is any door leaf surface visible and thus available for projection. Depending on structure of the door, shape or size of the projected information element may be adjusted based on change in the door leaf surface available for projecting. According to some embodiments, the projected information elements may be temporarily projected on the wall adjacent to the door when the door is open.

The FIG. 2 illustrates an enlarged view of content of some information elements projected on the floor in the FIG. 1 as seen directly from above the information elements. Information elements may comprise graphical and/or textual information.

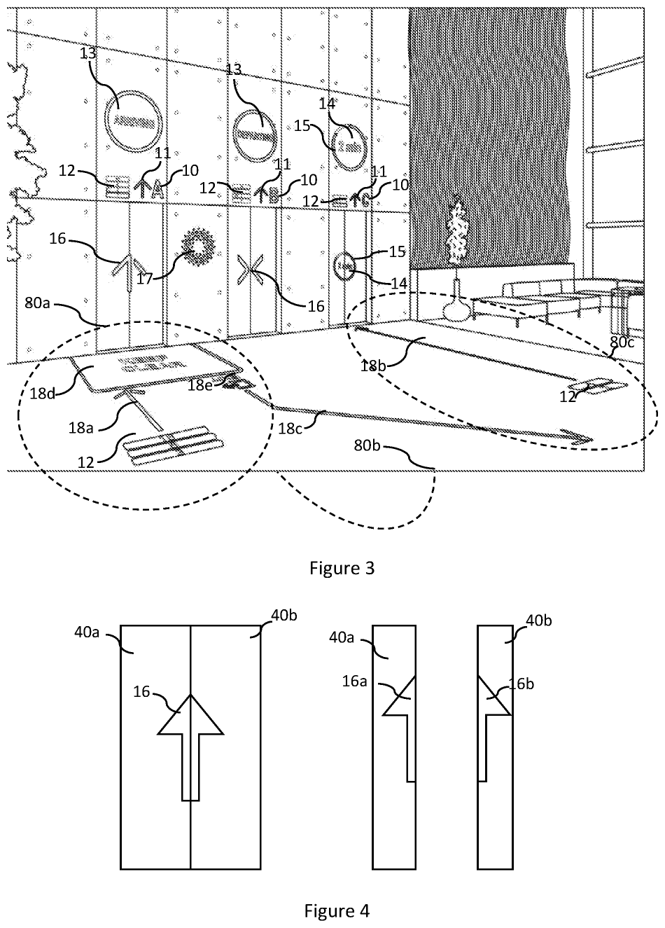

The FIG. 3 illustrates exemplary zones within the space. In this example, three zones (80a, 80b, 80c) have been defined, each representing area in vicinity of one of the elevator doors. By defining zones, dynamic adjustment of information elements can be made in a flexible way. For example, if one zone is crowded while others are not, projectors of the projection display apparatus that serve the crowded zone may be set into an operation mode defined for high level of crowdedness, while projectors of the projection display apparatus in other zones may use an operation mode that is fit for a non-crowded situation.

The FIG. 4 illustrates adjusting projection of information elements on an elevator door. When the door is closed, an information element (16) and/or some other image element may be projected on the one or more door leaves (40a, 40b). However, when the door is opened, door leaves move, and passengers move in the door opening. If the same information element (16) was still projected on the same location upon opening the door leaves, it would not be seen any more, and projection could cause glare of passengers passing through. Therefore, projected image(s) should be dynamically changed accordingly.

In this example, the exemplary door has two leaves that slide away from each other, which is a typical arrangement for example of an elevator door in a lobby. In this case, the projected information element is split into two halves (16a, 16b), each projected to one of the door leaves (40a, 40b), and each half (16a, 16b) of the information element is moved with the respective door leaf (40a, 40b). Appearance and/or content of the information element(s) projected on the door leaves may be changed during movement of door leave(s). Projection may be switched off or it may be temporarily moved on the adjacent wall(s) when door leaves are not visible.

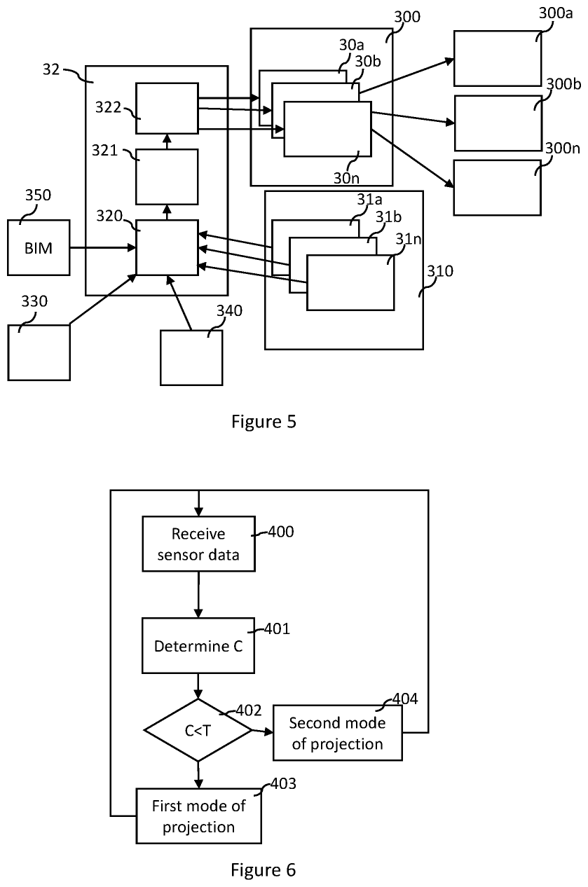

The FIG. 5 illustrates an apparatus for implementing the method of presenting information according to some embodiments. The apparatus comprises hardware and software elements. Main hardware elements are a projection display apparatus (300) comprising at least one projector (30a, 30b, . . . , 30n) configured to project a plurality of information elements (300a, 300b, . . . 300n), and a sensor apparatus (310) comprising at least one sensor (31a, 31b, . . . , 31n). Each projector (30a, 30b, . . . , 30n) is configured to project one or more information elements, depending on a mode of operation. For example, each projector (30a, 30b, . . . , 30n) may be configured to project one or more information elements on a selected surface of the space. Projectors (30a, 30b, . . . , 30n) may be directable so that direction of projection of an information element can be altered by redirecting the respective projector. Alternatively, projection of an information element can be altered by switching the information element to be projected by another projector.

According to some embodiments, the projection display apparatus (300) and the sensor apparatus (310) are comprised in a single, combined apparatus, which makes assembling easy and enables using a standardized software platform running on a computer or computer system (32) to control operation thereof. Interfaces between the projection display apparatus (300) and the software platform and between the sensor apparatus (310) and the software platform are preferably standardized. For example, the interface between the software platform and the projector or projectors may be based on a High Definition Multimedia Interface (HDMI), a Digital Visual Interface (DVI), a YPbPr interface, a Radio Corporation America (RCA) interface or a Video Graphics Array (VGA) interface.

According to some embodiments, the projection display apparatus (300) may be implemented as one device and the sensor apparatus (310) is physically separate from the projection display apparatus. The sensor apparatus (310) is preferably associated with the projection display apparatus (300), so that positions of the at least one sensor (31a, 31b, . . . , 31n) comprised in the sensor apparatus (310) and the projection display apparatus (300) can be optimized separately with respect to the specific space and respective operations thereof. Preferably, configurations of the physically separate projection display apparatus (300) and sensor apparatus (310) are also standardized, and standardized interfaces are defined between the projection display apparatus (300) and the software platform as well as between the sensor apparatus (310) and the software platform. In this respect the term “standardized” refers to a limited amount of possible apparatus combinations and interfaces. Interface(s) between the projection display apparatus (300) and the software platform as well as between the sensor apparatus (310) and the software platform are preferably standardized, irrespective of whether the projection display apparatus and the sensor apparatus are implemented as a single integrated apparatus or as separate devices. Interface(s) between the sensor apparatus (310) and the software platform may be based on a known interface standard, or proprietary interface(s) may be provided.

The plurality of sensors (31a, 31b, . . . , 31n) comprised in the sensor apparatus (310) comprises at least one of a camera, a camera array, a laser radar, a microwave radar and a wireless vision (Wi-Vi) device. Each sensor provides a respective sensor signal, which is processed by the sensor apparatus and/or a computer apparatus or system (32) on which the software platform is running, to determine current characteristics of the space.

The projection display apparatus (300) performs image projection. The projection display apparatus (300) comprises a projector or a plurality of projectors (30a, 30b, . . . , 30n) that enables projecting images on different surfaces in different directions, thus enabling displaying different information elements at different positions at surfaces that define the respective space. A plurality of projectors is preferred, so that the image and information element(s) projected by each projector can be easily optimized for the respective surface.

Operation of the projection display apparatus (300) is controlled by the software platform, which comprises software and/or firmware run on a computer apparatus or system (32). Data obtained by the sensor apparatus (310) is provided as input to the software, which comprises at least one input module (320) that receives various pieces of inputs for processing. At least one output module (322) provides output signals over an interface for the projectors (30a, 30b, . . . , 30n) of the projection display apparatus (300) for controlling projection of information elements by the one or more projectors (30a, 30b, . . . , 30n) of the projection display apparatus.

Interfaces for carrying signals to and from the computer apparatus or system (32) may be implemented over any wireless or wireline connection known in the art. Interface(s) towards the projection display apparatus (300) may be shared by two or more projectors of the projection display apparatus for example by multiplexing, or the interface(s) may enable parallel, simultaneous communication between the computer apparatus or system (32) and the plurality of projectors of the projection display apparatus (300). The projection display apparatus (300) comprises processing capability enabling the projection display apparatus to operate according to operation instructions received from the computer apparatus or system (32) over the respective interface(s).

The input module (320) receives input from an elevator control system (330) for enabling elevator-specific information elements to be projected by the projection display apparatus (300) according to instructions provided by the software platform (32). Real-time elevator specific information is received from the elevator control system (330), and this information is formatted into information elements by the software platform (32). The input module (320) may also receive input from a building information modeling (BIM) system (330). As known in the art, a BIM system (330) provides means for managing digital representations of physical and functional characteristics of places. Data received from the BIM system thus enables for example obtaining information of the design and construction of the space, thus enabling at least preliminary configuration and calibration of the projectors of the projection display apparatus (300). BIM data has static nature to a large extent, concerning information on more or less static features of the building, such as structure thereof. However, any changes and/or updates in the BIM information associated with the space are preferably used for dynamically adjusting and/or calibrating projections by the projection display apparatus (300). Further fine tuning of the adjustment, calibration and operation of the projector apparatus (300) is preferably based on data and/or information received by the software platform from other sources, such as the sensor module (310).

The input module (320) preferably comprises or is connected to a user interface (340) that enables an operator to define configuration settings for the projection display apparatus (300). For example, the user interface (340) may enable an operator to define which information elements are to be projected on which position among available surfaces of the space under which circumstances, and to define one or more functions and/or threshold values for parameters that are used by the software modules (321) to control output signals and to switch between different operation states.

The computer apparatus or system (32) receives one or more signals obtained by sensors of the sensor apparatus (310). Signals received by the computer apparatus or system (32) may be one or more of raw sensor signals, pre-processed sensor signals, processed sensor signals and parameter values determined on basis of signals received from the at least one sensor (31a, 31b, . . . , 31n) comprised in the sensor apparatus (310).

The software platform running on the computer apparatus or system (32) preferably comprises a plurality of software modules (321) configured to perform calibration tasks such as autofocus, projector brightness adjustment, projector keystone and warp adjustment as well as analyzing projecting surface quality and adjusting projected image according to projecting surface quality, while adjustment of the operation refers to tasks such as projector alignment, multiple projector blending, adapting the projections according to changes detected in the space, and controlling which information elements are projected where within the space.

According to some embodiments, a three-dimensional map or model of the space is generated at least partially based on the BIM data and/or the sensor data obtained by sensors of the sensor apparatus (310). Such three-dimensional map or model can be utilized for facilitating adjustment and/or calibration of an image projected by at least one projection display apparatus. According to some embodiments, a basic content of the three-dimensional map or model representing at least structure of the space is generated based on the BIM data, and possibly further information such as used materials, colors and more, while sensor data may be used for finetuning the three-dimensional map or model.

A level of crowdedness may be provided as a parameter from one or more sensors (31a, 31b, . . . , 31n) or from the sensor apparatus (310), which may combine data received from one or more sensors to determine the level of crowdedness. The level of crowdedness is preferably updated continuously in real time. If the level of crowdedness is not readily provided as a parameter from one of the sensors (31a, 31b, . . . , 31n) or the sensor apparatus (310), the input module (320) or one or more software modules (321) is configured to process signal(s) received from at least one of the sensors (31a, 31b, . . . , 31n) or the sensor apparatus (310) to determine the level of crowdedness. For example, the level of crowdedness may be expressed as a number of people, animals and/or items detected by the at least one sensor within the space, as a ratio or as a percentage. Type of parameter indicating the level of crowdedness is a design option. Crowdedness may be determined as a single parameter associated with the entire space, or the space may be divided into zones, so that crowdedness may be determined per zone, so that projections on different zones can be adjusted individually.

Effect of crowdedness in the space or in a zone of the space may also be detected indirectly using the sensor apparatus without determining a crowdedness parameter value. For example, the sensor apparatus may comprise one or more cameras which are used for supervising quality of projected information elements. Image(s) obtained by the one or more cameras is/are analyzed. If a projection of an information element is deemed to fail based on the analysis, it can be determined that there is for instance an obstacle or some other cause that impedes projection of the information element, and thus the projected image should be relocated. A failure of projected image may be deemed for example based on determining that quality of the projected image does not fulfill predefined quality criteria. If relocating the projection of the image does not cure the quality problem, it may be determined that there may be a problem in the projector that needs attention, and an alarm may be provided in the user interface.

Collaboration between various software modules enables generating output signals by the output module (322) that dynamically adapt to any changes in the space detected either on basis of the received sensor data, received BIM data, user input and/or a combination thereof. Changes that can be detected based on sensor data include, but are not limited to changes in lighting, temporary and/or permanent changes of places, sizes and positions of people, items and/or objects in the space, for example, people, animals, furniture or large packages, time of day. While places, sizes and positions of people, items and/or objects in the space based on the sensor data forms basis for determining a level of crowdedness, this primarily reflects detected characteristics of the space that are temporary in nature. Projections are dynamically adapted to permanent changes as well. Information concerning permanent changes, such as renovations causing color and/or material of walls and/or wall to be changed, adding or removing permanent structures in the space, may be obtained from the sensor apparatus (310) and/or from the BIM (350).

The FIG. 6 illustrates method steps according to some embodiments. In the step 400, sensor data is received that is based on detection by least one of the plurality of sensors (31a, . . . 31n) of the sensor module. In the step 401, a level of crowdedness (C) is determined based on said sensor data. In the step 402, determined level of crowdedness (C) is compared to a predetermined threshold value (T). If the level of crowdedness (C) remains below the predetermined threshold value, the computer or computer system (32) controls operation of the projector (300) into a first mode of operation, in which the projected images are designed and/or optimized for a space that is not crowded. For example, images comprising information elements may be projected on any surface of a lobby, such as the floor, wall(s) and/or elevator door(s) for achieving best clarity and efficiency for passenger guidance.

If the level of crowdedness (C) is found to exceed the predetermined threshold value (T) in the phase 402, the computer or computer system (32) controls operation of the projection display apparatus (300) into a second mode of operation, as illustrated by the step 404. In the second mode of operation, projected images and content thereof are optimized for a crowded lobby. For example, projection of images on the floor may be suppressed and respective information may, at least partially, be projected on wall(s) and/or elevator door(s).

Adjusting projection of information elements on an elevator door as illustrated in the FIG. 4 may be based on information received from the elevator control system and/or from the sensor apparatus. A signal may be received from the elevator control system that indicates the exact moments of opening and closing the elevator door, and operation of a projector projecting an information element or part of it on the elevator door leaf can be controlled based on this information. Alternatively, or in addition, projection of an information element or part of it on the elevator door may be controlled based on information received from the sensor apparatus. Using sensors for controlling adjustment of the information element may improve accuracy of adjustment for example in a case that speed of movement of the door leaves is different from what is expected.

A mode of operation of the projection display apparatus comprises defining content, location and/or size of the projected image for each of the at least one projector in the projector apparatus. Content of the projected image refers to the one or more information elements included in the projected image. Some of the projectors may even be switched off in at least one operation mode so that they do not project any images. This facilitates power saving in circumstances, in which projection of the image would not add value to passengers and/or might even be harmful for the passengers.

For simplicity, a single threshold value (T) for crowdedness is applied in this example, but more than one threshold values can be applied, in which case each interval defined by the plurality of threshold values is preferably associated with a specific mode of operation of the projector apparatus. Furthermore, as already discussed above, crowdedness may be defined for a plurality of zones defined within the space, which enables information elements projected by each projector can be optimized individually for each zone.

It is apparent to a person skilled in the art that as technology advanced, the basic idea of the invention can be implemented in various ways. The invention and its embodiments are therefore not restricted to the above examples, but they may vary within the scope of the claims.

1. A method for presenting information in a space by a projection display apparatus comprising at least one projector, the method comprising:
projecting, by said projection display apparatus, at least one image on at least one surface within the space, the at least one image comprising at least one information element;
i) detecting a change in the space and/or one or more zones within the space based on at least one of: a change in building information management (BIM) data received from a BIM system, sensor data received from at least one sensor associated with or included in the projection display apparatus, data received from an elevator control system; and/or
ii) determining a level of crowdedness of the space and/or one or more zones within the space based on sensor data received from at least one sensor associated with or included in the projection display apparatus; and/or
iii) detecting a failure of projection of the at least one image based on sensor data received from the at least one sensor based on the image not fulfilling predefined quality criteria; and
adjusting content, location and/or size of the at least one projected image based on the detected change in the space and/or the determined level of crowdedness of the space and/or the detected failure of projection.

2. The method according to claim 1, wherein the space is any one of an elevator lobby and a lobby with a security gate and/or an escalator landing.

3. The method according to claim 1, wherein size and/or brightness of the at least one information element is increased when the determined level of crowdedness of the space and/or one or more zones within the space exceeds a predetermined threshold value.

4. The method according to claim 1, wherein projecting at least one information element is suspended when the determined level of crowdedness of the space and/or one or more zones within the space exceeds a predetermined threshold value.

5. The method according to claim 1, wherein said at least one image comprises at least one information element projected on a floor surface of the space, and wherein:
projecting the at least one information element on the floor surface is suspended i) on basis the detected change in the space and/or in one or more zones within the space, and/or ii) when the determined level of crowdedness of the space and/or in one or more zones within the space exceeds a predetermined threshold value, and/or iii) when a failure of projection of the at least one image on the floor surface is detected, and/or
projecting the at least one information element on the floor surface is automatically switched into projecting the at least one information element on a wall surface of the space i) on basis the detected change in the space and/or in one or more zones within the space, and/or ii) when determined level of crowdedness of the space and/or in one or more zones within the space exceeds a predetermined threshold value, and/or iii) when a failure of projection of the at least one on the floor surface is detected.

6. The method according to claim 1, wherein the at least one surface is at least one door leaf, and wherein the at least one image projected on the at least one door leaf is dynamically adjusted according to status and/or movement of the at least one door leaf based on at least one of the sensor data and the data received from the elevator control system.

7. The method according to claim 1, wherein the space is an elevator lobby and wherein the information comprises at least one of a hall lantern of an elevator, a destination guidance display, an elevator guide, an elevator direction indicator and a current floor indicator next to a landing device, an elevator identification information, a progress bar for elevator arrival, a time estimate for elevator arrival, an indication of elevator doors opening, a warning on closing elevator doors, an elevator out of order indication, an elevator out of service indication, a destination name and/or a logo associated with the destination, emergency markings for firemen elevators, guidance for users, such as guidance for not to use elevators in case of fire, amount of people currently in the elevator, building information, advertising, decorative projections, building branding, elevator branding, infotainment, and advertisement.

8. The method according to claim 1, comprising
adjusting and/or calibrating the at least one projected image based on a three-dimensional map or model of the space generated based on at least one of the BIM data and the sensor data.

9. The method according to claim 1, wherein the at least one sensor comprises at least one of a camera, a camera array, a laser radar, a microwave radar and a wireless vision (Wi-Vi) apparatus.

10. An apparatus for presenting information in a space, the apparatus comprising:
a projection display apparatus configured to project at least one image on at least one surface within the space, the at least one image comprising at least one information element representing a piece of said information;
at least one sensor associated with or included in the projection display apparatus; and
optionally, an interface for receiving building information management (BIM) data from a BIM system; and
optionally, an interface for receiving information from an elevator control system;
wherein the apparatus comprises at least one of:
a first module configured to determine a level of crowdedness of the space and/or one or more zones within the space based on sensor data received from said at least one sensor;
a second module configured to detect a change in the space and/or one or more zones within the space based on at least one of: a change in the BIM data, sensor data received from at least one sensor associated with or included in the projection display apparatus, data received from the elevator control system; and
a third module configured to detect a failure of projecting the at least one image based on sensor data received from the at least one sensor, wherein the failure is detected based on the image not fulfilling predefined quality criteria;
and wherein the apparatus further comprises:
a fourth module configured to automatically adjust content, location and/or size of the projected image based on i) a detected change in the space and/or one or more zones within the space and/or ii) the determined level of crowdedness of the space and/or one or more zones within the space and/or iii) the detected failure of projecting the projected image.

11. The apparatus according to claim 10, wherein the fourth module is configured to increase the size and/or brightness of the at least one information element when the determined level of crowdedness of the space and/or one or more zones within the space exceeds a predetermined threshold value.

12. The apparatus according to claim 10, wherein the fourth module is configured to cause suspending of projecting at least one information element when the determined level of crowdedness of the space and/or one or more zones within the space exceeds a predetermined threshold value.

13. The apparatus according to claim 10, wherein said at least one image comprises at least one information element projected on a floor surface of the space, and wherein the fourth module is configured to cause projecting the at least one information element on the floor surface to be suspended i) on basis the detected change in the space and/or in one or more zones within the space, and/or ii) when the determined level of crowdedness of the space and/or one or more zones within the space exceeds a predetermined threshold value, and/or iii) based on the detected failure of projecting the at least one image, and/or
wherein the third module is configured to cause automatically switching from projecting the at least one information element on the floor surface into projecting the at least one information element on a wall surface of the space i) on basis the detected change in the space and/or in one or more zones within the space, and/or ii) when determined level of crowdedness of the space and/or one or more zones within the space exceeds a predetermined threshold value and/or iii) based on the detected failure of projecting the at least one image.

14. The apparatus according to claim 10, wherein the at least one surface is at least one door leaf, and wherein the apparatus comprises
a fifth module configured to dynamically adjust the at least one projected image projected on the at least one door leaf according to status and/or movement of the at least one door leaf based on at least one of the sensor data and the data received from the elevator control system.

15. The apparatus according to claim 10, wherein the space is an elevator lobby and wherein said information comprises at least one of a hall lantern of an elevator, a destination guidance display, an elevator guide, an elevator direction indicator and a current floor indicator next to a landing device, an elevator identification information, a progress bar for elevator arrival, a time estimate for elevator arrival, an indication of elevator doors opening, a warning on closing elevator doors, an elevator out of order indication, an elevator out of service indication, a destination name and/or a logo associated with the destination, emergency markings for firemen elevators, guidance for users, such as guidance for not to use elevators in case of fire, amount of people currently in the elevator, building information, advertising, decorative projections, building branding, elevator branding, infotainment, and advertisement.

16. The apparatus according to claim 10, further comprising
a fifth module configured to generate a three-dimensional map or model of the space based on at least one of the BIM data and the sensor data, wherein the third module or a fifth module is further configured to adjust and/or calibrate the at least one projected image based on said three-dimensional map or model.

17. The apparatus according to claim 10, wherein the at least one sensor comprises at least one of a camera, a camera array, a laser radar, a microwave radar and a wireless vision (Wi-Vi) apparatus.

18. A computer program product embodied on a non-transitory computer readable medium and comprising computer executable code that causes, when run on a computer device or system, an apparatus to perform the method according to claim 1.

19. The method according to claim 2, wherein size and/or brightness of the at least one information element is increased when the determined level of crowdedness of the space and/or one or more zones within the space exceeds a predetermined threshold value.

20. The method according to claim 2, wherein projecting at least one information element is suspended when the determined level of crowdedness of the space and/or one or more zones within the space exceeds a predetermined threshold value.
